(19) United States
(12) Patent Application Publication
(10) Pub. No.: US 2018/0045581 A1
(43) Pub. Date: Feb. 15, 2018

(54) APPARATUS AND METHODS FOR CONTINUOUS TEMPERATURE MEASUREMENT IN MOLTEN METALS

(71) Applicant: Ardee Technologies Pvt. Ltd., Rourkela, Odisha (IN)

(72) Inventor: Vinay Goda, Rourkela, Odisha (IN)

(73) Assignee: Ardee Technologies Pvt. Ltd., Rourkela, Odisha (IN)

(21) Appl. No.: 15/552,120

(22) PCT Filed: Feb. 17, 2016
(86) PCT No.: PCT/IB16/00348

§ 371 Date: Aug. 18, 2017

(30) Foreign Application Priority Data
Feb. 18, 2015 (IN) 190/KOL/2015

(51) Int. Cl. G01K 7/04

(52) U.S. Cl. CPC G01K 7/04; G01K 1/08

(57) ABSTRACT

Temperature probes and methods for continuously measuring very high temperatures of molten metals in vessels are described. A temperature probe may include material that permits venting of gases from the probe's interior during use. The porous bed may be added in powder form at a head of the probe, adjacent to getter material. A retaining plate may be tack-welded to cover the porous bed and allow venting of gases.

### RELATED APPLICATION

This application claims priority to Indian application No. 190/KOL/2015 titled, “Porous Heat Insulating Bed in a Probe for Continuous Temperature Measurement in Molten Steel Tundish,” filed on Feb. 18, 2015, which is incorporated by reference in its entirety.

### FIELD OF INVENTION

The technology relates to metal manufacturing, and to temperature probes for continuously measuring molten metals in vessels.

### BACKGROUND

The manufacturing of metals can involve several stages of handling molten metal. Metal compositions may be melted in a first vessel and transferred to one or more vessels during a metal manufacturing process. For example, a metal composition may be first heated in a furnace, and transferred by a ladle to a caster or tundish from which it may be poured into molds. At each stage of a metal manufacturing process, the temperature of the melt may be held at a target temperature for a period of time. Appreciable temperature deviations from a target temperature may adversely affect the quality of the final metal product. Accordingly, it is desirable to monitor, as accurately as possible, a temperature of the molten metal through the metal manufacturing process.

Several types of temperature measurement techniques have been developed for measuring high temperatures of molten metals. One approach is to use thermoelectric devices, e.g., thermocouples. Some measurements with thermocouples may involve fixing a thermocouple probe at the end of a long lance, and dipping the thermocouple probe into the molten metal to measure the temperature of the metal melt. This is conventionally done in an intermittent fashion. Disadvantages with intermittent measurement of temperature is that the manufacturing process may be interrupted for the measurement, and there may be substantial time intervals between the measurements so that close process control of the melt temperature may not be possible. Additionally, the thermocouple probes may only be used once or a few times before they become damaged and inaccurate or inoperable.

Optical-pyrometry-based techniques have been developed for measuring the temperature of liquid metals. Such techniques can provide faster measurements of melt temperatures. Conventional optical measurements comprise piercing an optical probe, mounted on a lance, through a layer of slag covering the metal. Again, these measurements are intermittent, and the slag and measurement technique leads to high wear and a short lifetime of the probe.

### SUMMARY

A temperature probe for molten metal is described that can be installed in a vessel wall and used for continuous temperature measurements of molten metals. Embodiments of the temperature probe may be used for multiple batches of molten metal. To reduce wear of the temperature probe, a porous bed of material may be included at an end of a chamber of the probe that houses a thermocouple. The porous bed permits venting of gases that would otherwise accelerate degradation of the temperature probe. The probe is arranged in a way to facilitate assembly of the probe and installation of the porous bed of material.

Some embodiments relate to a temperature probe for measuring temperature of molten metal. The temperature probe may comprise an outer refractory sheath having a central bore extending from a first end of the refractory sheath toward a distal end of the refractory sheath, a thermocouple sensor mounted within the central bore, getter material filling a first region of the central bore around the thermocouple sensor, and a porous bed filling a second region of the central bore at the first end of the refractory sheath.

In some aspects, a temperature probe may further comprise a connector assembly and a separator tube arranged to support the thermocouple sensor within the central bore, and include one or more retaining plates attaching the connector assembly to the refractory sheath. In some implementations, the porous bed and the one or more retaining plates are configured to vent gases from the central bore. Additionally, or alternatively, a porosity of the porous bed is at least 40%. In some cases, a first retaining plate of the one or more retaining plates is tack welded to the connector assembly. The tack welding may allow escape of gases from the porous bed. In some aspects, one of the one or more retaining plates is cemented to the outer refractory sheath and the cement does not seal gases within the central bore.

In some implementations, a connector assembly of a temperature probe comprises a connector tube, a connector formed from two connector halves mounted within the connector tube, and a first cold junction contact and a second cold junction contact mounted within the connector. In some aspects, a temperature probe further comprises a protector tube covering the thermocouple sensor and at least a portion of the separator tube. An end of the separator tube and an end of the connector tube may be held within the connector. In some cases, the connector tube does not extend into the porous bed.

In one or more of the foregoing configurations, a temperature probe is further configured to be inserted into a wall of a vessel that holds molten metal. The various aspects, features, and implementations may be included in any suitable combination, and the temperature probe may be used in one of the following methods. According to some embodiments, a method of measuring temperatures of molten metal may comprise acts of installing a temperature probe in a wall of a vessel, applying an electrical current through a thermocouple sensor within the probe, and venting gases from an interior of the probe when operating the probe at temperatures over 200 degrees Celsius.

In some aspects, the venting may comprise venting gases through a porous bed located at a head of the probe. In some implementations, a method may further comprise reducing carbon monoxide with a getter material internal to the probe.

A temperature probe of one or more of the foregoing configurations may be fabricated using a method of assembling a temperature probe. The method of assembly may comprise acts of cementing a sheath retaining plate to a protective refractory sheath, subsequently inserting a thermocouple sensor and protector tube into a central bore of the refractory sheath, wherein the protector tube is connected to a connector tube of a connector assembly, subsequently adding getter material to fill a first portion of the central bore, subsequently adding a porous material to the central bore to form a porous bed at a head of the refractory sheath, and securing the connector assembly to the sheath retaining plate.

In some aspects, the act of securing does not trap gases within the central bore of the refractory sheath. According to some implementations, the act of securing comprises tack welding. In some aspects, the act of cementing does not trap gases within the central bore of the refractory sheath. According to some implementations, a method of assembly may further comprise assembling the connector assembly by placing the protector tube into a first half of a connector, placing a first cold-junction contact and a second cold-junction contact into the first half of the connector, placing a second half of the connector over the first half of the connector, and inserting the first and second halves of the connector into the connector tube

The foregoing and other aspects, embodiments, and features of the present teachings can be more fully understood from the following description in conjunction with the accompanying drawings.

### BRIEF DESCRIPTION OF DRAWINGS

The skilled artisan will understand that the figures, described herein, are for illustration purposes only. It is to be understood that in some instances various aspects of the embodiments may be shown exaggerated or enlarged to facilitate an understanding of the embodiments. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1 depicts a vessel containing a molten metal wherein a temperature probe is mounted in the vessel wall, according to some embodiments;

FIG. 2 depicts components of a temperature probe for molten metals, according to some embodiments;

FIG. 3 depicts a retaining plate for a temperature probe, according to some embodiments;

FIG. 4 is a perspective view that depicts a connector for a temperature probe, according to some embodiments; and

FIG. 5 is a flow diagram depicting steps associated with a method for manufacturing a temperature probe, according to some embodiments.

The features and advantages of the embodiments will become more apparent from the detailed description set forth below when taken in conjunction with the drawings.

### DETAILED DESCRIPTION

During the manufacture of metals, it can be beneficial to monitor the temperature of molten metal throughout the manufacturing process, e.g., during the initial heating of a metal composition in a furnace, during transfer in a ladle, and during the casting process. Accurate knowledge of the liquid metal temperature can improve the quality of the end product as well as the productivity of the metal plant. For example, in some steel manufacturing processes, a melt may be raised to a temperature of about 1650° C. and maintained at that temperature two within about ±5° C. for a period of time. At a later stage, e.g., in a tundish or caster, the melt may be maintained at a temperature between about 1520° C. to about 1550° C., depending on the metal composition, with a tolerance of ±1° C. For some metal manufacturing systems, unnecessarily high temperatures can consume a few megawatts of power for each degree Celsius, leading to a waste of energy and money. Excess heating can further result in using excess alloys, excessive refractory wear, and also metal loss. Less heating can result in insufficient processing of metals, which can result in rejection of the whole batch. Temperature errors in a casting process can ruin the ability to cast the metal, resulting in a unusable batch that must be reprocessed.

Measurement of liquid metal temperatures has been performed conventionally with single-use, dip-type immersion probes containing a thermocouple sensor. Continuously measuring temperature in molten metal using probes with thermocouples has been performed previously with limited success. Examples of high-temperature probes can be found in U.S. Pat. No. 5,388,908 and in U.S. Pat. No. 5,209,571, both of which are incorporated herein by reference. An example of a high-temperature probe designed for continuous temperature measurements in a metal melt is described in U.S. Pat. No. 8,071,012, which is incorporated herein by reference.

The inventor has found that such conventional temperature probes can be unreliable and degrade more quickly than desired (e.g., within one or a few “runs” or “batches” of metal melts where temperature is monitored continuously), and therefore need replacement at a higher frequency and cost than desired. The inventor has recognized and appreciated that conventional probe designs are not optimally suited for continuous temperature measurements in a vessel or tundish during steel manufacturing. In such measurements, the probe may be mounted to extend through a wall of the vessel, and the temperature of the probes “cold junction” can increase significantly during use. Stresses associated with thermal expansion can fatigue electrical connections at the cold junction, for example. As a result, temperature measurements may become erratic and unreliable, or the probe may simply malfunction.

The inventor has further recognized and appreciated that degradation of a high-temperature probe may occur due to trapped gases (which may include corrosive gases) at the interior of the probe that degrade the thermocouple junction and/or crack a protective sheath of the probe or a protective tube housing the probe's thermocouple sensor. One reason for the failure of a temperature probe during continuous temperature measurements is the entrapped gases such as N₂, O₂, CO, CO₂, SiO, water vapor etc. that expand during use and cause cracks to develop in a tube housing the thermocouple and/or in an outer protective sheath of the probe. The inventor has recognized and appreciated that despite best precautions, it is impossible to completely eliminate in-situ generation of some gases within the probe, such as CO, CO₂, SiO, and water vapor, at the very high temperatures associated with metal melts.

Previous probe designs have employed “getter” material at the interior of the probe to reduce corrosive gases. In conventional designs, the getter material may be sealed in the probe using a refractory cement. However, the inventor has recognized and appreciated that the cementing process can introduce moisture into the probe that can expand during use to cause failure of the probe. U.S. patent publication No. 2007/0053405 describes a pressed or extruded getter tube that is installed in a probe, and that is retained with a contact piece. However, the contact piece is retained in the probe's sheath near the cold junction with cement. The inventor has recognized and appreciated that the extrusion adds a processing step to the manufacture of the probe, as well as introduces organics and other compounds in the probe which might liquefy or gasify and form harmful gases, degrade probe components, and influence temperature measurements during use at very high temperatures. Additionally, the cement used to retain the contact piece can still introduce water vapor to the interior of the probe upon assembly.

Embodiments of temperature probes described herein include improvements in the construction of temperature probes that may be used in very high-temperature environments (e.g., at temperatures in excess of 500° C.). Some embodiments relate to, but are not limited to, probes that house thermocouple-type sensors, which may be used in molten metal temperature measurement applications. The improved temperature probes may be used for measuring temperatures continuously in metal melts and vessels, for example. According to some embodiments, the probes include an insulating and porous bed installed near the cold junction of the probe that permits venting of high-temperature gases from the interior of the probe that would otherwise accelerate degradation of the probe. In some implementations, the probes do not include organics or other materials at the interior of the probe that may liquefy or gasify at low-temperatures (e.g., below about 200° C.). For example, getter material may be added as a powder to the probes interior, and need not be solidified in an extra processing step with a binder containing organics. Additionally, the probe is assembled in such a way that vapor from curing cement is not trapped within a core of the probe. Durability and reliability of the temperature probes are improved so that the associated measurement system may be useful for measuring temperature continuously in high-temperature and very-high-temperature melts for prolonged periods. The embodied probes can provide greater accuracy of temperature monitoring during a metal manufacturing process, for example.

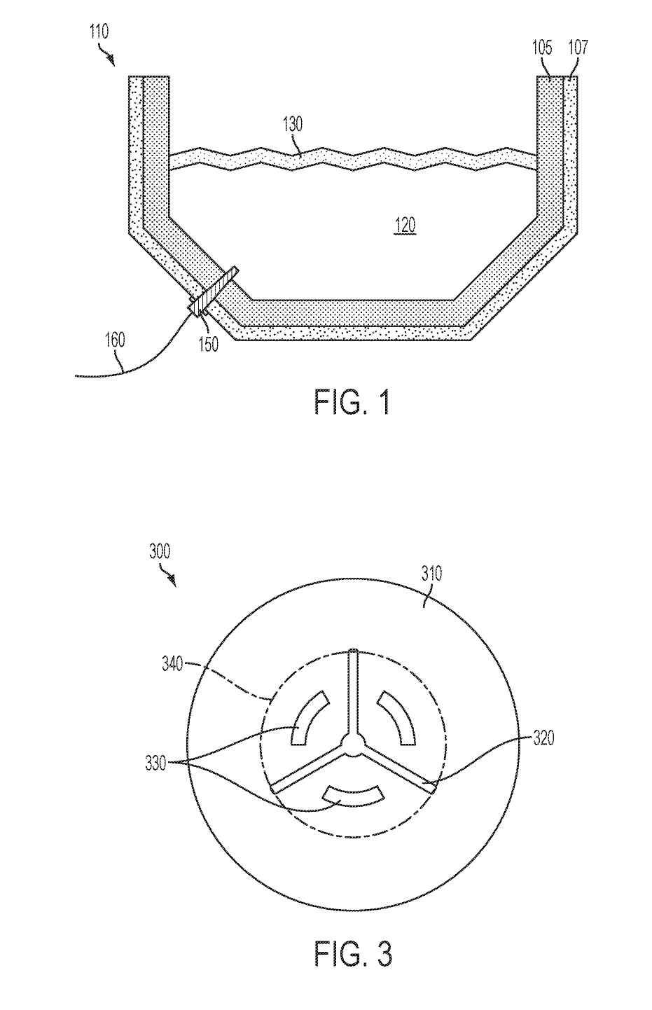

A temperature sensing probe 150 of the present embodiments may be mounted through a side wall of a vessel 110 (e.g., a tundish) for steel melts as depicted in FIG. 1, for example. The probe 150 may be secured in place by one or more well blocks (not shown individually) and an embedding mortar mix. The well block or blocks may form a portion of an inner lining 105 of the vessel and include a hole into which the probe 150 fits and extends through to the interior of the vessel 110. The mortar mix may be used to secure the probe to the well block(s) and prevent any leakage of molten metal through the lining to the vessel wall 107 or exterior of the vessel. When filled with molten metal 120, slag 130 may form over the molten metal. The molten metal may comprise any composition used in the manufacture of commercial or specialized metals.

The vessel 110 may be a vessel of a furnace (e.g., an arc furnace) that is used to heat a metal composition, a ladle, a tundish, or a mold in which liquid metal is cooled. In some embodiments, the vessel 110 comprises a outer shell 107, which may be formed of metal, and an inner lining 105, which may be formed of refractory material (e.g., refractory blocks or refractory concrete).

In some embodiments, the temperature probe 150 may be adapted to be readily removed from the vessel and replaced with a new probe. For example, the temperature probe may be configured to be inserted into a receptacle that allows the probe to extend through the wall of the vessel. The probe may be configured to be fastened to the outer shell 107 with screws or a locking mechanism that can be undone when replacing the temperature probe. The probe may be replaced between batches of metal melts, when the vessel 110 has been emptied.

When mounted in the vessel, a “head” of the probe that includes the probe's cold junction may extend outside the vessel 110, as depicted in FIG. 1. One or more retaining plates may be installed around the probe's head to secure the probe to the vessel wall 107. The probe's cold junction may project out from the vessel wall 107, and include a connector assembly to which a cable 160 with mating connector or a wireless data acquisition or data transmission system (not shown) is attached. According to some embodiments, the probe's thermocouple sensor is located within an interior portion of the probe that projects into the interior of the vessel, and the temperature of the molten metal may be sensed continuously as the metal is processed. A thermocouple signal representative of a temperature of the molten metal 120 may be transferred through the cable 160 or the wireless system to an external device where the signal may be recorded and/or processed to determine a temperature of the melt.

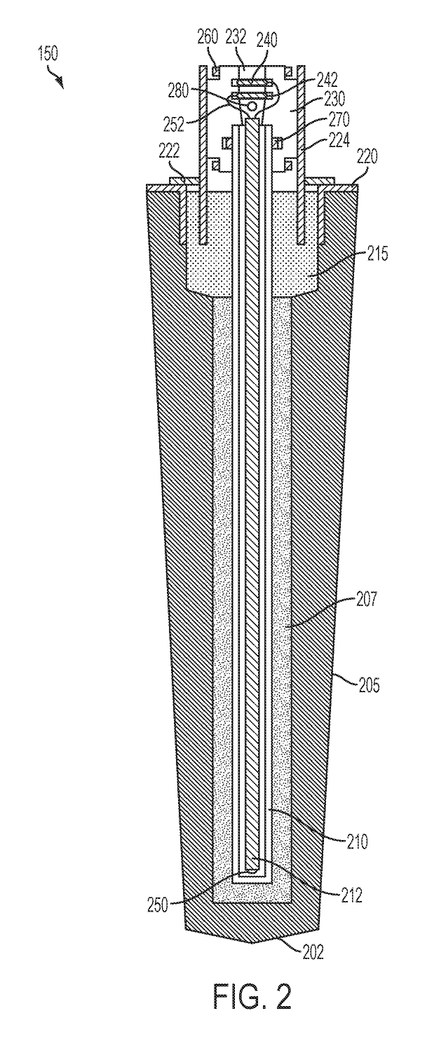

In further detail and referring now to FIG. 2, a temperature probe 150 may comprise a noble metal thermocouple sensor 250 (sometimes referred to as a “hot junction”) located at a distal end 202 of the probe. The sensor may be protected from the very high temperature of the metal melt by an outer refractory sheath 205 and one or more refractory tubes 210, 212. Getter material 207 may be installed in powder form between the outer refractory sheath 205 and the one or more protective tubes to reduce corrosive gases that may enter to the interior of the probe. The head of the temperature probe 150 may include a porous bed 215, a connector 230 for the probe's cold junction and associated hardware to attach the connector, refractory tubes, and thermocouple sensor to the probes refractory sheath 205.

In some embodiments, the thermocouple sensor 250 may comprise dissimilar metals or metal compositions that are welded together, e.g., using a tungsten inert gas (TIG) weld. One or more metal compositions of the thermocouple sensor 250 may include platinum. One or more metal compositions may additionally include rhodium. A thermocouple assembly may comprise two long conductive leads that extend from the head of the temperature probe to the thermocouple sensor 250. An end of a first thermocouple lead 252 may connect to a first contact 242 of the cold junction (e.g., via a TIG weld, or any other suitable method to provide electrical connection). An end of a second thermocouple lead may connect to a second contact 240 of the cold junction. In operation, electrical current may be applied across the thermocouple sensor 250 via the cold junction contacts 240, 242, and a resistance to the current flow may depend upon the temperature of the thermocouple sensor 250. A measurement of voltage across the sensor may be used to determine a temperature of the molten metal, for example.

In some implementations, the thermocouple leads may be housed within a separator tube 212. The separator tube may be a double-bore tube, having two separated holes running interior along the length of an otherwise solid rod. The two leads of the thermocouple may run separately through the two holes between the thermocouple sensor 250 and the cold junction connectors 240, 242. The two bores may separate and electrically isolate the two long conductive leads of the thermocouple sensor. According to some embodiments, the separator tube may be formed from one or more refractory materials. For example, the separator tube 212 may be formed from any combination of the following materials: silicon oxide (e.g., SiO₂), aluminum oxide (e.g., Al₂O₃), magnesium oxide (e.g., MgO), and zirconium oxide (e.g., ZrO₂).

In some implementations, the separator tube and thermocouple sensor may be encased along a majority of the length of the separator tube 212 by a single-bore, closed-end refractory “protector” tube 210. In some embodiments, only an end portion of the separator tube at which the thermocouple sensor 250 is located may be encased by the protector tube 210. The protector tube may shield the thermocouple sensor 250, and yet allow thermal conduction of heat to the sensor for temperature measurement. The protector tube may be dense and substantially prevent any mass transfer and significantly reduce the transport of harmful gases to the sensor 250, thus prolonging the life of the thermocouple. For example, a partial pressure of harmful gases within the protector tube may be less than one-tenth the level of harmful gases immediately outside the protector tube when the temperature probe 150 is in use. According to some embodiments, the protector tube 210 may be formed from one or more refractory materials. For example, the protector tube may be formed from any combination of the following materials: silicon oxide (e.g., SiO₂), aluminum oxide (e.g., Al₂O₃), magnesium oxide (e.g., MgO), and zirconium oxide (e.g., ZrO₂).

The thermocouple sensor 250 and its long leads, the separator tube 212, and the protector tube may be assembled into a central bore of a closed-end outer protective sheath 205. The outer sheath may be formed from a combination of the following refractory oxides (silicon oxide (e.g., SiO₂), aluminum oxide (e.g., Al₂O₃), magnesium oxide (e.g., MgO), and zirconium oxide (e.g., ZrO₂)), and further include a thermally conducting material (e.g., graphite, silicon carbide, etc.) in the mixture. In some embodiments, the sheath 205 may comprise any one or combination of: zirconia, partially stabilized magnesia, partially stabilized calcia, partially stabilized scandia, partially stabilized yttria, stabilized zirconia, alumina, graphite, spinel, and boron nitride. At least a portion of the outer sheath near the thermocouple sensor 250 may directly contact the molten metal when in use, allowing for heat conduction to the sensor due to the sheath's thermally conductive property. The outer sheath 205 may be dense to substantially prevent any mass transfer through its walls, and may significantly reduce the transport of gases through its walls.

In some implementations, the sheath 205 includes an outer glaze coating (not shown), which inhibits adhesion of metal to the sheath, reduces erosion, and prolongs the life of the probe 150 during pre-heating of the vessel into which the probe is installed. The glaze coating may comprise zinc borosilicate frits and a clay which may be applied over the sheath and fired to form the coating. The coating may be applied from a solution (e.g., sprayed or painted onto the outer sheath surface) and then the sheath may be fired at over 1100° C. to harden the coating. The hardened coating may have a thickness between about 10 microns and about 100 microns. The coating may reduce oxidation of graphite in the outer sheath during a preheating stage of the tundish

According to some embodiments, the sheath 205 may taper in diameter from the cold junction to the distal end 202, as depicted in FIG. 2, though it may have other forms in other embodiments. The length of the sheath may be between 350 mm and 550 mm, according to some embodiments, though it may be shorter or longer in other embodiments. A diameter of the sheath may be between 50 mm and 100 mm, in some implementations, though smaller or larger diameters may be used in other implementations. An inner diameter of the sheath may be between 20 mm and 60 mm. The tapering or form of the sheath 205 may be configured to match a mating taper or receptacle in a refractory block or blocks of a vessel 110, so that the probe registers consistently to a location when installed in a vessel. For example, the probe may insert and be stopped by the mating hole, such that the thermocouple sensor 250 locates to an approximately consistent distance from the vessel's lining 105 at the interior of the vessel. This can assure that the temperature of different batches of metal melts are measured at approximately the same distance into the melt with different probes, so that the quality of the produced metal is consistent.

In some embodiments, one or more refractory blocks may be provided with a temperature probe 150. A refractory block may be made of any suitable material (e.g., any one or combination of: alumina, magnesium oxide, magnesia carbon, and spinel). A block may have a thickness T that is approximately equal to a thickness of refractory blocks or refractory cement that is used in the inner lining 105 of the vessel 110. A refractory block provided with the temperature probe may be in any suitable shape, and may have a hole, or portion of a hole (e.g., a quarter or half hole formed at an edge of the brick), into which the temperature probe 150 fits. The refractory block may not be attached to the temperature probe, so that the block may be placed in the inner lining 105 of the vessel 110 and the temperature probe inserted through the outer shell 107 and into the hole formed by the block or blocks.

In an annular region between the outer protective sheath 205 and the protector tube 210 or double-bore tube 212, a “getter” material 207 may be added. The getter material may react with any gases that might be present or generated during use of the thermocouple, and help protect the thermocouple sensor. According to some embodiments, the getter material 207 consists predominantly of a refractory metal oxide (e.g., aluminum oxide or magnesium oxide) along with a metal powder (e.g., aluminum powder). The getter material 207 may be in the form of a free-flowing powder that can be poured into the annular region during manufacture of the temperature probe 150. According to some embodiments, the getter powder is not densely packed and has significant void spaces, which allow space for any thermal expansions during the high-temperature usage of the probe. For example, the getter material may flow back out of the probe if inverted and not retained in the probe.

In some embodiments, the getter material 207 partially fills the annular region within the central bore of the sheath 205, e.g., only part way to the head of the probe within the sheath. In some implementations, the getter material may extend only over a portion of the temperature probe that protrudes into a vessel 110 beyond the refractory lining 105, when installed in the vessel. For example, if the length of a probe's sheath 205 is 450 mm, a total thickness of the vessel wall and lining is 150 mm, and a head of the sheath mounts flush with an outer surface of the vessel wall 107, then the getter material may fill the annular region and stop a distance of approximately 150 mm or less from the head of the sheath. As such, the getter material 207 may be installed at least in a portion of the temperature probe where the sheath directly contacts molten metal. In some embodiments, the getter material may fill between approximately 60% and 90% of the annular region within the central bore of the sheath.

Near the cold junction, a bed of porous insulating material 215 may fill a remaining portion of the annular region and extend along the remaining length of the sheath 205 towards the cold junction. A diameter of the central bore in the sheath may increase near the cold junction, as depicted in FIG. 2, in some embodiments. In other embodiments, the diameter of the central bore in the sheath may be uniform along the sheath. The porous insulating material 215 may extend up to the cold junction connector assembly, in some embodiments. In some implementations, the porous insulating material 215 may fill between approximately 5% and approximately 40% of the probe's central bore. The porous insulating material may comprise any material (e.g., aluminum oxide, zirconium oxide, silica, etc.) that can withstand high temperatures (e.g., between about 200° C. and about 500° C.) for a long period of time without significant degradation or substantial loss of porosity. For example, the porous insulating material should not sinter at operating temperatures where the porous bed is located. When installed, the porous insulating should provide an open porosity of at least 40% by volume ratio. In some embodiments, the porosity may be between 40% and 80%. In some cases, the porosity may be between 40% and 60%. A high porosity allows for escape of gases from the probe interior, and includes thermally-insulating gaps to reduce heating of the cold junction.

According to some embodiments, a sheath retaining plate 220 may be affixed to an end of the protective sheath 205. The sheath retaining plate may be formed from any suitable metal (e.g., galvanized steel such as EDD grade steel which is hot dipped galvanized, stainless steel such as 304 or 316 grade, a mild steel composition, etc.) and may be adhered to the head of the sheath with refractory cement, for example. In some implementations, stainless or galvanized steel is preferred for metal components of at the head of the probe to prevent rusting of the components during use. The inventor has recognized and appreciated that rusting of plain steel can occur during high-temperature use and lead to a loosening of the probe's connector assembly and cold-junction contacts.

According to some implementations, the sheath retaining plate 220 may be formed from a stamped or cut plate (depicted in FIG. 3) to form a disc 300 with radial cut-outs 320 and additional cut-outs 330. A thickness of the plate may be between 1 mm and 3 mm. The radial cut-outs 320 allow the disc to be subsequently drawn to form an inner circular opening (indicated by the dashed line 340) with wall extensions that extend approximately 90 degrees from the plate, as indicated in FIG. 2. The additional cut-outs 330 may be of any suitable shape, and provide for improved adhesion of the sheath retaining plate 220 to an interior wall of the sheath 205.

The sheath retaining plate 220, after being formed, may be adhered to the head of the sheath 205 with refractory cement, prior to insertion of the thermocouple sensor and cold-junction connector assembly. The cement may be cured and any associated vapor allowed to escape from the central bore of the sheath prior to assembling remaining components of the probe. In this manner, water vapor may not be trapped in the probes interior during manufacture of the probe.

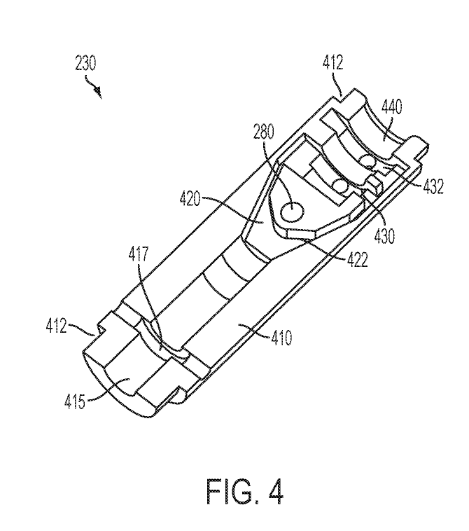

Referring again to FIG. 2, the cold junction connector assembly may include several pieces of hardware that attach the thermocouple sensor 250, separator tube 212, protector tube 210, and cold junction contacts 240, 242 together and to the outer protective sheath 205. According to some embodiments, a connector 230 of the connector assembly is formed in two halves. One-half of a connector 230 is depicted in the perspective view of FIG. 4. The connector halves may be configured to receive at least the cold junction contacts 240, 242 and separator tube 212, be joined together, and inserted into a connector tube 224. An inner retaining plate 222 may be attached to the connector tube 224 (e.g., via tack welding) and attached to the sheath retaining plate 220 to secure the thermocouple sensor 250, separator tube 212, protector tube 210, and cold junction assembly to the probe's outer protective sheath 205.

In some implementations, a single retaining plate may be used to secure the thermocouple sensor 250, separator tube 212, protector tube 210, and cold junction assembly to the probe's outer protective sheath 205. For example, the sheath retaining plate may be formed to provide adhesion to the sheath 205 and edges or surfaces for tack welding to the connector tube 224. There may be one or more holes in the sheath retaining plate to allow filling of the getter material and porous bed material. A cover plate may later be added to retain the porous bed.

The connector tube 224 may be formed from any suitable grade of mild steel, which may be galvanized, or stainless steel. The connector tube may have an outer diameter between 10 mm and 30 mm, and may have a wall thickness between 1.5 mm and 4 mm, according to some embodiments. A length of the connector tube may be between 60 mm and 150 mm. The connector tube may extend into the porous bed 215 to improve rigidity of the connector assembly. In some cases, the connector tube may not extend into the porous bed 215 to improve thermal isolation of the connector assembly. Other dimensions for the connector tube may be used in other embodiments.

In some embodiments, an inner retaining plate 222 does not form an air tight seal with the connector tube 224 or sheath retaining plate 220 over the porous bed 215. For example, tack welding may be used at plural separated locations to attach the inner retaining plate. Additionally or alternatively, the inner retaining plate 222 may include one or more holes for venting gas. Accordingly, gases that may accumulate at an interior of the probe may vent through the porous bed 215 to an exterior of the temperature probe when the probe is in use. In some embodiments, one or more holes or porous plugs may extend from the porous bed through the wall of the protective sheath 205 in a region of the sheath that contacts the refractory lining 105 of a vessel 107, so that gases may vent into the lining region within the vessel wall 107. In some embodiments, one or more venting holes may be formed through the connector tube 224 to facilitate venting of gases from the porous bed 215.

Referring again to FIG. 4, a half of the connector 230 may include a central trench 415 for receiving a tube (e.g., the protective tube 210 and/or the separator tube 212). Along the central trench, there may be a groove 417 for receiving a retaining clip 270 (e.g., a spring clip depicted in FIG. 2) that retains the received tube within the connector 230 when the halves of the connector are assembled together. At an end of the central trench 415 there may be a first lead trench 420 and a second lead trench 422 through which leads of the thermocouple may extend to the probe's cold junction contacts 242, 240 (shown in FIG. 2). A connector half may further include a first cold-junction-contact groove 430 and a second cold-junction-contact groove 432 configured to receive the probe's cold-junction contacts 242, 240. A connector half may further include an opening 440 through which electrical contacts of a mating connector may extend and make electrical contact to the cold-junction contacts 242, 240.

According to some embodiments, the connector body 410 may be formed out of any suitable material that can withstand high temperatures. In some implementations, the connector body may be formed from any combination of the following materials: silicon oxide (e.g., SiO₂), aluminum oxide (e.g., Al₂O₃), magnesium oxide (e.g., MgO), and zirconium oxide (e.g., ZrO₂). The ends of the connector halves may include detents 412 for receiving spring clips 260 that hold the two halves of the connector 230 together. A connector may include a hole 280 into which a pin or spring pin may be inserted. The pin may extend through the walls of the connector tube 224 to secure the assembled connector 230 within the connector tube.

In some implementations, the cold-junction contacts 242, 240 may be in the form of a ring, though other shapes may be used, and may be formed from any suitable conductive metal (e.g., copper), plated material, or metal composition (e.g., a copper-beryllium alloy). Resilient contacts on a mating connector may make electrical contact with the cold-junction contacts 242, 240 when the mating connector is attached to the head of the probe.

According to some embodiments, the protective sheath 205 lasts for long durations in molten steel, thus allowing for continuous temperature measurement. The protective sheath can last for durations up to 8 hours in a tundish containing molten steel at temperatures between about 1520° C. to about 1550° C. Since the thermocouple sensor 250, protector tube 210, and separator tube 212 themselves are not capable of withstanding the harsh molten metal conditions for a long duration, the probe assemblies of the present embodiments allows the thermocouple sensor to remain operational for greatly extended periods of time. The inventor has used an embodiment of the temperature probe 150 in a tundish for continuous temperature measurements during 28 successive batches of molten steel that were transported through the tundish.

Various aspects of a temperature probe 150 include its compatibility with existing hardware and systems in conventional steel plants, so that it may be easily integrated into existing process systems to provide better accuracy and continuous measurements, which can improve the quality of produced steel.

Another aspect of an embodied temperature probe is that the porous insulating material 215 provides an improved level of thermal isolation between the cold junction and the getter material 207 and protective sheath 205, as compared to a solid plug or cement used in conventional probes. This thermal isolation reduces heating of the cold junction, which can improve the accuracy of the measurements and lifetime of the cold junction and probe. Less heating of the probe head can also reduce thermal stresses on and increase the lifetime of connectors, cables, and/or other equipment attached to the probe head.

Another aspect of an embodied temperature probe is that the porous bed 215 permits easy escape of gases that would otherwise be entrapped inside the thermocouple assembly and expand on heating of the thermocouple assembly, possibly leading to damage. The gases might originate from assembly of the thermocouple (e.g., water vapor from cement), from low-temperature volatiles within the assembly (e.g., organic binder components), or might originate from other sources, such as burning of carbonaceous compounds on the furnace lining that permeate the sheath 205 at high temperatures.

Another aspect of an embodied temperature probe is that potting compound, such as a hydraulically setting cement to seal or embed the getter material, is not needed. This can avoid the entrapment of water vapor or other gaseous components in the interior of the probe that, upon heating, might cause degradation or catastrophic failure of the thermocouple, protector tube, and/or protective sheath. Additionally, elimination of the potting compound to seal the getter material simplifies and accelerates assembly of the probe.

Another aspect of an embodied temperature probe is a reduction in the amount of getter material that is needed in the probe compared to conventional probes. In an embodied temperature probe 150, the getter material extends part way from the thermocouple to the end of the refractory sheath 205, rather than the full length of the refractory sheath. Since the getter material 207 is more expensive than material for the porous bed 215, a reduction in getter material can reduce the overall cost of manufacturing the probe.

Another aspect of an embodied temperature probe is a simplification of assembly of the various probe components compared to conventional probes. Only one cementing step is needed for structural support (cementing the sheath retaining plate 220 to the head of the outer sheath 205). This step can be done at the time of manufacturing the outer sheath, and only involves the two components. The remaining assembly steps for a probe 150 require no cementing for structural support. Thus, once the sheath and sheath retaining plate are prepared, a complete temperature probe may be assembled quickly and be ready for use. The assembly eliminates a waiting period for a potting compound to set before using the probe. In some embodiments, the single cementing step can occur in parallel with other assembly steps of the probe (e.g., preparation and/or assembly of the thermocouple and connector assembly).

When placed in operation, a temperature probe 150 may be mounted in a vessel that contains molten metal, for example, and connected to a measurement instrument. An electrical sensing current may be applied by the measurement instrument across the probe's hot junction (e.g., via a cable 160), while a voltage across the hot junction is monitored. As the probe heats, a resistance of the hot junction will change dependent upon the temperature of the hot junction. From measured voltage and/or resistance values and one or more calibration values for the probe, temperatures of the melt may be continuously determined. At very high temperatures, potentially harmful gases such as CO, CO₂, SiO may be reduced by getter material 207 within the probe. Additionally, potentially harmful gases may be vented from the probe's interior through the bed of porous material 215.

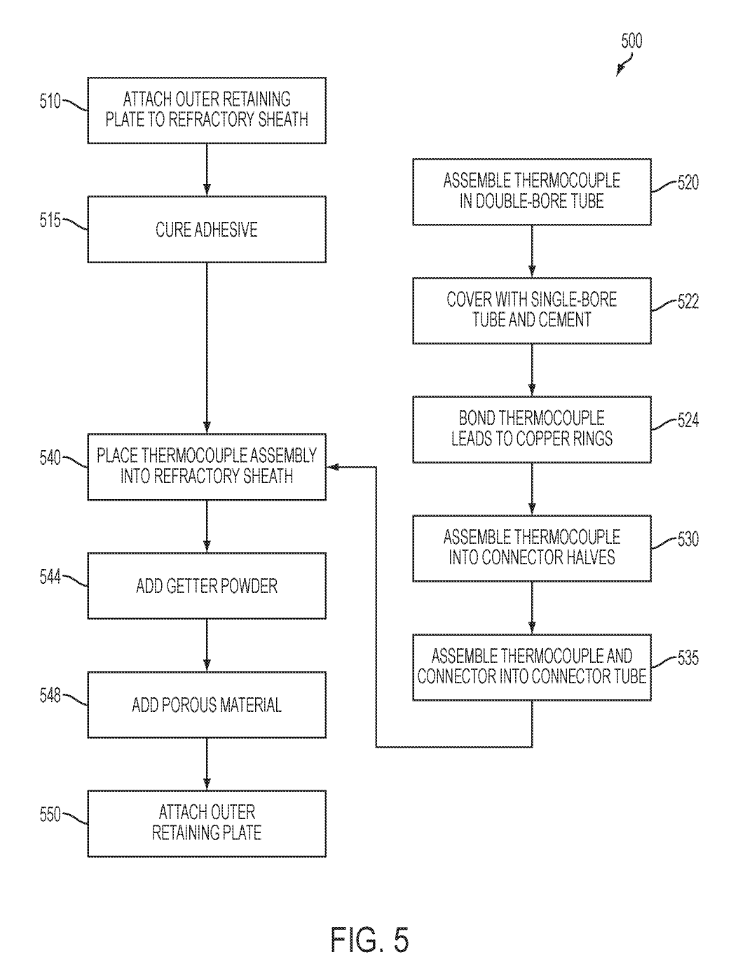

A method of assembling a temperature probe 150 will now be described in connection with the flow diagram of FIG. 5, though the described method is only one example in which assembly may be performed and is not intended to limit the order or number of steps performed. According to some embodiments, a method 500 may comprise attaching (act 510) an outer sheath retaining plate 220 to the protective sheath 205. In some implementations, a formed sheath 205 may be prepped by applying an alumina cement mixture, for example, to the inner wall at the head of the sheath. The formed sheath retaining plate 220 may then be pushed into place, so that the plate's wall extensions contact the cement along the inner wall of the sheath. Excess cement may be spread over the plate's wall extensions and into cut-outs 330. This sub-assembly may be then allowed to rest for roughly 3-4 hours to let the surface moisture of the cement dry out. In some embodiments, the sub-assembly may be placed in an oven at 150° C. for about 24 hours to cure (act 515) the cement. In some embodiments, after removal from the oven, a flame treatment may be applied to the head of the sheath to permanently harden the cement and remove any traces of moisture that might remain.

A method 500 of assembling a temperature probe may further include assembling (act 520) a thermocouple in a separator tube 212. According to some embodiments, thermocouple leads are inserted into the double-bore separator tube 212 and cut to a suitable length. The thermocouple sensor may be made by joining the thermocouple leads with a TIG weld. The sensor's hot junction may then be cleaned (e.g., using acetone) and the leads pulled back, so that the hot junction rests on a bridge at the end of the double-bore tube between the two bores.

In some implementations, a single-bore protector tube may be installed (act 522) over the double-bore tube and a small amount of alumina cement, for example, may be applied to the ends of the protector tube as a seal to prevent gases from entering the tubes. The tubes and thermocouple leads may fit closely, so that the interior spaces in the tubes see very little cement surface area. Closely fitting the tubes and thermocouple leads can reduce any amount of water vapor or other gases that might enter into the interior of the tubes from the cement. A split-ring spring clip 270, for example, may be place over the protector tube 210.

The free ends of the thermocouple leads may be spot welded (act 524) to the cold junction contacts 242, 240 (e.g., copper-beryllium rings), and the contacts may be inserted into their grooves in a first half of the connector 230. The tube assembly with thermocouple sensor may be placed (act 530) in the central trench 415 of one connector half. The second half of the connector may be assembled over the first half and split-ring spring clips 260 may be placed over the connector's detents 412.

The connector 230 with separator tube, thermocouple sensor, and protector tube may be assembled (act 535) in the connector tube 224. For example, the connector may be inserted into the connector tube, aligned, and rotated, so that a pin or spring pin can be inserted through a hole in the connector tube and through a pin hole 280 in the connector 230.

The resulting assembly can be positioned (act 540) in the central bore of the refractory sheath 205. A getter material may then be added (act 544) into the remaining annular region in the sheath 205 that lies between the sheath's inner diameter and the outer diameter of the double-bore tube 212 or protector tube 210. A vibrator may be used to vibrate the assembly and compact the getter powder as it fills the void. The vibration is maintained at a level that does not separate the constituents of the getter material. A predetermined volumetric quantity of getter powder may be selected, so that the getter material fills the void to a predetermined level that is below the head of the sheath. In some embodiments, the sheath 205 and connector tube 224 may be held firmly by a jig to maintain alignment and position of the thermocouple 250 and protector tube 210 within the sheath 205 as the getter material is added.

According to some embodiments, alumina balls may be added (act 548) to form the porous bed 215 at the head of the temperature probe 150. The balls may be added to fill the remaining void to approximately the head end of the sheath 205. In some embodiments, there may be one or more holes through walls of the connector tube 224 that allow the porous bed material to move to the interior of the connector tube.

The inner retaining plate 222 may be placed over the connector tube 224 and slid into contact with the sheath retaining plate 220. Tack welding may be used in some embodiments to secure the inner retaining plate to the connector tube and the sheath retaining plate. In some implementations, the inner retaining plate may include one or more holes to allow venting of gas. The welding of the inner retaining plate provides structural support between the connector tube 224 and the outer sheath 205.

As may be appreciated, the probe components (e.g., connector halves, cold-junction contacts, connector tube, powder getter material, powder porous material) and single cementing step which can be done in parallel or early in the assembly process allows for rapid assembly and use of the temperature probes.

In some implementations, an assembled probe may be calibrated by placing it in a known thermal environment and determining a resistance of the thermocouple sensor 250 at one or more temperatures.

The technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Additionally, a method may include more acts than those illustrated, in some embodiments, and fewer acts than those illustrated in other embodiments.

Having thus described at least one illustrative embodiment of the invention, various alterations, modifications, and improvements will readily occur to those skilled in the art. Such alterations, modifications, and improvements are intended to be within the spirit and scope of the invention. Accordingly, the foregoing description is by way of example only and is not intended as limiting. The invention is limited only as defined in the following claims and the equivalents thereto.

1. A temperature probe for measuring temperature of molten metal, the temperature probe comprising:
an outer refractory sheath having a central bore extending from a first end of the refractory sheath toward a distal end of the refractory sheath;
a thermocouple sensor mounted within the central bore;
getter material filling a first region of the central bore around the thermocouple sensor; and
a porous bed filling a second region of the central bore at the first end of the refractory sheath.

2. The temperature probe of claim 1, further comprising:
a connector assembly and a separator tube arranged to support the thermocouple sensor within the central bore; and
one or more retaining plates attaching the connector assembly to the refractory sheath.

3. The temperature probe of claim 2, wherein the porous bed and the one or more retaining plates are configured to vent gases from the central bore.

4. The temperature probe of claim 1 wherein a porosity of the porous bed is at least 40%.

5. The temperature probe of claim 2, wherein a first retaining plate of the one or more retaining plates is tack welded to the connector assembly.

6. The temperature probe of claim 5, wherein the tack welding allows escape of gases from the porous bed.

7. The temperature probe of claim 5, wherein one of the one or more retaining plates is cemented to the outer refractory sheath and the cement does not seal gases within the central bore.

8. The temperature probe of claim 2, wherein the connector assembly comprises:
a connector tube;
a connector formed from two connector halves mounted within the connector tube; and
a first cold junction contact and a second cold junction contact mounted within the connector.

9. The temperature probe of claim 8, further comprising a protector tube covering the thermocouple sensor and at least a portion of the separator tube.

10. The temperature probe of claim 9, wherein an end of the separator tube and an end of the connector tube are held within the connector.

11. The temperature probe of claim 8, wherein the connector tube does not extend into the porous bed.

12. The temperature probe of claim 1, wherein the probe is configured to be inserted into a wall of a vessel that holds molten metal.

13. A method of measuring temperatures of molten metal, the method comprising:
installing a temperature probe in a wall of a vessel;
applying an electrical current through a thermocouple sensor within the probe; and
venting gases from an interior of the probe when operating the probe at temperatures over 200 degrees Celsius.

14. The method of claim 13, wherein the venting comprises venting gases through a porous bed located at a head of the probe.

15. The method of claim 13, further comprising reducing carbon monoxide with a getter material internal to the probe.

16. A method of assembling a temperature probe, the method comprising:
cementing a sheath retaining plate to a protective refractory sheath;
subsequently inserting a thermocouple sensor and protector tube into a central bore of the refractory sheath, wherein the protector tube is connected to a connector tube of a connector assembly;
subsequently adding getter material to fill a first portion of the central bore;
subsequently adding a porous material to the central bore to form a porous bed at a head of the refractory sheath; and
securing the connector assembly to the sheath retaining plate.

17. The method of claim 16, wherein the act of securing does not trap gases within the central bore of the refractory sheath.

18. The method of claim 16, wherein the act of securing comprises tack welding.

19. The method of claim 16, wherein the act of cementing does not trap gases within the central bore of the refractory sheath.

20. The method of claim 16, further comprising assembling the connector assembly by:
placing the protector tube into a first half of a connector;
placing a first cold-junction contact and a second cold-junction contact into the first half of the connector;
placing a second half of the connector over the first half of the connector; and
inserting the first and second halves of the connector into the connector tube.
